(19) United States
(12) Patent Application Publication
(10) Pub. No.: US 2025/0269292 A1
(43) Pub. Date: Aug. 28, 2025

(54) HEAD STRUCTURE OF ROBOT

(71) Applicant: ROBOSEN ROBOTICS (SHENZHEN) CO., LTD, Shenzhen (CN)

(72) Inventors: Xiaosen CHEN, Shenzhen (CN); Liming ZHENG, Shenzhen (CN); Yangyang TIAN, Shenzhen (CN)

(73) Assignee: ROBOSEN ROBOTICS (SHENZHEN) CO., LTD, Shenzhen (CN)

(21) Appl. No.: 19/059,322

(22) Filed: Feb. 21, 2025

(30) Foreign Application Priority Data
Feb. 26, 2024 (CN) 202410206068.9

(51) Int. Cl. A63H 3/36; A63H 3/40; B25J 11/00

(52) U.S. Cl. CPC A63H 3/365; A63H 3/40; B25J 11/0015; A63H 2200/00

(57) ABSTRACT

A head structure of a robot is provided. The robot includes a head, a body, a right arm and a left arm located on both sides of the body, a right leg and a left leg symmetrically located below the body; main parts of the robot are equipped with servos to ensure that the robot can move flexibly, and can perform human-computer interaction; the back of the body is equipped with wings and a backpack; the head is equipped with a three-link linkage which drives a mouth structure to close and open, the mouth of the robot can close and open flexibly; the head is also equipped with anthropomorphic eyes which can rotate up and down, left and right, so it is achieved that the eyes move anthropomorphically; and the mouth structure and eyes can be independently controlled, increasing fun of the robot.

### CROSS REFERENCE TO THE RELATED APPLICATIONS

This application is based upon and claims priority to Chinese Patent Application No. 202410206068.9, filed on Feb. 26, 2024, the entire contents of which are incorporated herein by reference.

### TECHNICAL FIELD

The present invention relates to a technical field of robot, specifically, relates to a head structure of a robot.

### BACKGROUND

In the prior art, only few robots are equipped with sound effects and colorful lights, movement ranges of joints of robots are small, the robots can move only by manually bending their joints, they are unable to move independently and interact with humans, their eyes and mouths can't move, and all of these makes the robots lack fun.

A Chinese utility model patent with authorization announcement number CN202700071U discloses a fun robot toy that walks like dancing, the robot toy includes a robot shaped body, a hand component and a feet component actively connected to the body, and a head connected to the body. A driving mechanism is set in the body, gears are set at the connection of the feet component and the body, the driving mechanism is connected with the gears to drive the gears to rotate, when the gears rotate, the feet component is driven to open or close. Lower end of the feet component is equipped with lateral rollers, when the feet component opens or closes, the lateral rollers drive the robot toy to walk laterally, making it feel like dancing when the robot toy moves. After sliding a distance, the two feet of the robot open; then the two feet close together, slid a distance, and open; and then the two feet close together, slid a distance, and open, looking interesting. However, the robot toy lacks sound effects and colorful lights, and can only perform sliding movements, which is not realistic enough and lacks fun.

A Chinese invention patent with publication number CN115847447A discloses a smart robot that can walk upright on two feet, the robot include a head, a body, a right arm and a left arm located on both sides of the body, a right leg and a left leg symmetrically located below the body. The head, the body, the right arm, the left arm, the right leg and the left leg are all equipped with servos to ensure that the robot can move flexibly and perform human-computer interaction. The back of the robot is equipped with a weapon and a backpack, a jet cylinder is set in the backpack, this makes the robot be with colorful light effects when the robot works. The exterior of a main structure of the robot is wrapped in a soft rubber sleeve, making the robot be beautiful and dust-proof. However, mouth and eyes of the robot can't move, and it is not the maximum restoration of an image of the Buzz Lightyear in cartoon.

### SUMMARY

In order to overcome defects in the prior art, a purpose of the present invention is to provide a head structure of a robot, which solves the problems that the Buzz Lightyear robot is passive and manual, it's appearance is not sufficiently restored, only few Buzz Lightyear robots are equipped with sound effects and colorful lights, their movement ranges of joints are small, they are unable to move independently, their eyes and mouth structure can't move.

To realize the foregoing purposes, a scheme of the present invention is as follows.

The present invention provides a head structure of a robot, the robot includes a head, a body, a right arm and a left arm located on both sides of the body, a right leg and a left leg symmetrically located below the body; the back of the body is equipped with wings and a backpack; the head is equipped with a three-link linkage which drives a mouth structure to close and open, so the mouth of the robot can close and open flexibly; the head is also equipped with anthropomorphic eyes which can rotate up and down, left and right, so it is achieved that the eyes move anthropomorphically; the mouth structure and eyes can be independently controlled (with independent programming and no fixed movement sequence), increasing fun of the robot. The smart robot of the present invention realizes anthropomorphic movement and human-computer interaction of the Buzz Lightyear, and maximally reproduces the image of the Buzz Lightyear in cartoon.

Preferably, the mouth structure includes a mouth servo, the mouth servo controls the three-link linkage to realize up and down movement of the mouth.

In any of the above solutions, it is preferred that a hood is equipped outside the head, the head includes a rear shell, an internal structure, and a front shell from back to front, the eyes are mounted on the internal structure; the front shell is embedded with a hard rubber face and a soft rubber face, and edge of the soft rubber face is adhered to the hard rubber face.

In any of the above solutions, it is preferred that the mouth structure is mounted in the middle of the internal structure, the mouth structure passes through the front shell, the hard rubber face, and the soft rubber face, and protrudes outward.

In any of the above solutions, it is preferred that the internal structure includes a neck connector, the three-link linkage, a basic frame, and a head printed circuit board (PCB).

In any of the above solutions, it is preferred that the front of the basic frame is equipped with a left and right movement slider of eyes which drives the eyes to move left and right, and an up and down movement slider of eyes which drives the eyes to move up and down; the back of the basic frame is equipped with a fixing bracket of eye servo, a right eye servo and a left eye servo are set on the fixing bracket of eye servo; the right eye servo controls the left and right movement slider of eyes to realize left and right movement of eyes, the left eye servo controls the up and down movement slider of eyes to realize up and down movement of eyes.

In any of the above solutions, it is preferred that the left and right movement slider of eyes and the up and down movement slider of eyes are assembled together to form an assembly on which a right eye joint and a left eye joint are equipped. After being powered on, the robot's eyes can rotate up and down, left and right, making the robot more vivid, and adding fun.

In any of the above solutions, it is preferred that the right eye joint has a hole into which a right eye is inserted, the left eye joint has a hole into which a left eye is inserted. The left and right movement slider of eyes and the up and down movement slider of eyes are driven by the right eye servo and the left eye servo, making the robot perform anthropomorphic movement and human-computer interaction, and maximally reproducing the image of the Buzz Lightyear in cartoon.

In any of the above solutions, it is preferred that circuits of head are collected on the head PCB, and driven by a head servo; the neck connector is connected with a neck servo in the body to drive a neck to rotate.

In summary, the head structure of the robot of the present invention has the following advantages: main parts of the robot are equipped with servos to ensure that the robot can move flexibly, and can perform human-computer interaction; the back of the body is equipped with the wings and the backpack, the head is equipped with the three-link linkage which drives the mouth structure to close and open, so the mouth of the robot can close and open flexibly, increasing fun of the robot; after being powered on, the robot's eyes can rotate up and down, left and right, making the robot more vivid, and adding fun.

### BRIEF DESCRIPTION OF THE DRAWINGS

FIG. 1 is a structural schematic diagram of a preferred embodiment of a head structure of a robot according to the present invention.

FIG. 2 is a split diagram of a head in the preferred embodiment shown in FIG. 1 of the head structure of the robot according to the present invention.

FIG. 3 is a structural schematic diagram of eyes in the preferred embodiment shown in FIG. 2 of the head structure of the robot according to the present invention.

FIG. 4 is a split diagram of the preferred embodiment shown in FIG. 3 of the head structure of the robot according to the present invention.

Explanation of reference numbers in drawings:

head 1, hood 11, head servo 12, rear shell 13, internal structure 14, neck connector 141, three-link linkage 142, basic frame 143, head PCB 144, front shell 15, hard rubber face 16, soft rubber face 17, eyes 18, right eye 181, left eye 182, right eye servo 183, left eye servo 184, fixing bracket of eye servo 185, left and right movement slider of eyes 186, up and down movement slider of eyes 187, right eye joint 188, left eye joint 189, mouth structure 19, mouth servo 191.

### DETAILED DESCRIPTION OF THE EMBODIMENTS

The following description is only an illustration and not a limitation of the present disclosure, application or use. Embodiments of a head structure of a robot of the present invention are further described in accordance with drawings.

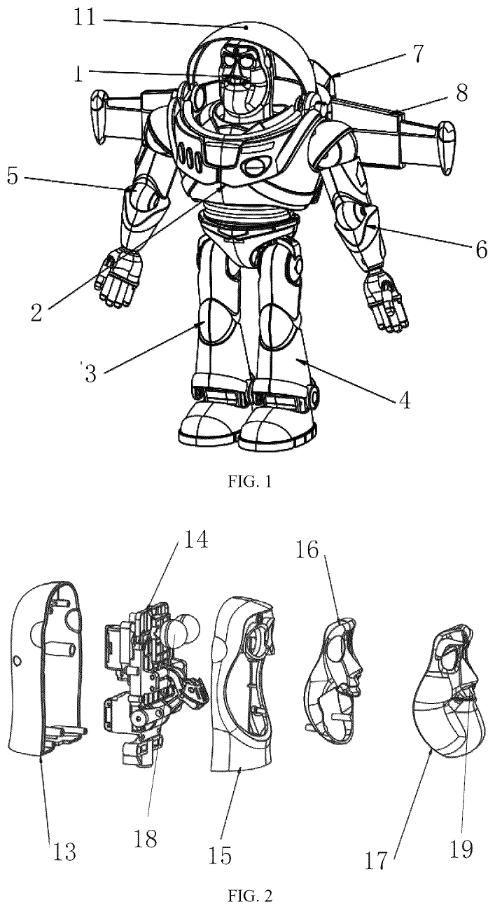

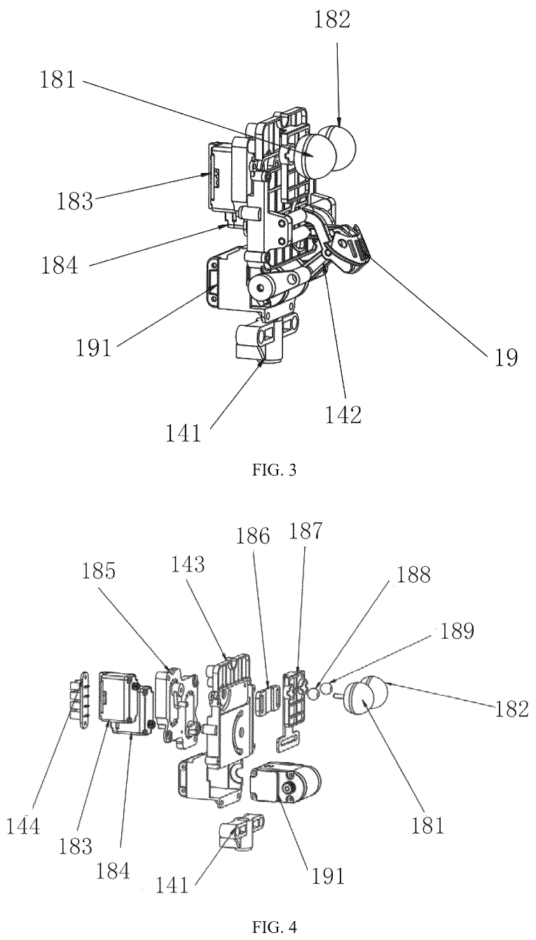

Structural schematic diagrams of a head structure of a robot of the present invention are shown in FIG. 1-FIG. 4.

The present invention provides the head structure of the robot, the robot includes a head 1, a body 2, a right arm 5 and a left arm 6 located on both sides of the body 2, a right leg 3 and a left leg 4 symmetrically located below the body 2; the back of the body 2 is equipped with wings 8 and a backpack 7; the head 1 is equipped with a three-link linkage 142 which drives a mouth structure 19 to close and open, so the mouth of the robot can close and open flexibly; the head 1 is also equipped with anthropomorphic eyes 18 which can rotate up and down, left and right, so it is achieved that the eyes move anthropomorphically; the mouth structure 19 and eyes 18 can be independently controlled (with independent programming and no fixed movement sequence), increasing fun of the robot. The smart robot of the present invention realizes anthropomorphic movement and human-computer interaction of the Buzz Lightyear, and maximally reproduces the image of the Buzz Lightyear in cartoon.

In the embodiment, the mouth structure 19 includes a mouth servo 191, the mouth servo 191 controls the three-link linkage 142 to realize up and down movement of the mouth.

In the embodiment, a hood 11 is equipped outside the head 1, the head 1 includes a rear shell 13, an internal structure 14, and a front shell 15 from back to front, the eyes 18 are mounted on the internal structure 14; the front shell 15 is embedded with a hard rubber face 16 and a soft rubber face 17, and edge of the soft rubber face 17 is adhered to the hard rubber face 16.

In the embodiment, the mouth structure 19 is mounted in the middle of the internal structure 14, the mouth structure 19 passes through the front shell 15, the hard rubber face 16, and the soft rubber face 17, and protrudes outward.

In the embodiment, the internal structure 14 includes a neck connector 141, the three-link linkage 142, a basic frame 143, and a head PCB 144.

In the embodiment, the front of the basic frame 143 is equipped with a left and right movement slider of eyes 186 which drives the eyes to move left and right, and an up and down movement slider of eyes 187 which drives the eyes to move up and down; the back of the basic frame 143 is equipped with a fixing bracket of eye servo 185, a right eye servo 183 and a left eye servo 184 are set on the fixing bracket of eye servo 185; the right eye servo 183 controls the left and right movement slider of eyes 186 to realize left and right movement of eyes, the left eye servo 184 controls the up and down movement slider of eyes 187 to realize up and down movement of eyes.

In the embodiment, the left and right movement slider of eyes 186 and the up and down movement slider of eyes 187 are assembled together to form an assembly on which a right eye joint 188 and a left eye joint 189 are equipped. After being powered on, the robot's eyes can rotate up and down, left and right, making the robot more vivid, and adding fun.

In the embodiment, the right eye joint 188 has a hole into which a right eye 181 is inserted, the left eye joint 189 has a hole into which a left eye 182 is inserted. The left and right movement slider of eyes 186 and the up and down movement slider of eyes 187 are driven by the right eye servo 183 and the left eye servo 184, making the robot perform anthropomorphic movement and human-computer interaction, and maximally reproducing the image of the Buzz Lightyear in cartoon.

In the embodiment, circuits of the head 1 are collected on the head PCB 144, and driven by a head servo 12; the neck connector 141 is connected with a neck servo in the body 2 to drive a neck to rotate. The head servo 12 drives the head to rotate left and right.

It is not difficult for person having ordinary skill in the art to understand that the head structure of the robot of the present invention includes any combination of various parts in the specification. Due to space limitations and in order to make the specification be simple and clear, these combinations are not introduced in details. However, after reading the specification, it is self-evident that the scope of the present invention composed of any combination of the various parts in the specification.

1. A head structure of a robot, wherein
the robot comprises a head, a body, a right arm, a left arm, a right leg and a left leg, wherein the right arm and the left arm are located on both sides of the body, the right leg and the left leg are symmetrically located below the body, and a back of the body is equipped with wings and a backpack; and
the head is equipped with a three-link linkage configured to drive a mouth structure to close and open; a mouth of the robot is configured to close and open flexibly; the head is also equipped with anthropomorphic eyes configured to rotate up and down, left and right; the mouth structure and eyes are configured to be independently controlled.

2. The head structure of the robot according to claim 1, wherein the mouth structure comprises a mouth servo, wherein the mouth servo controls the three-link linkage to realize up and down movement of the mouth.

3. The head structure of the robot according to claim 1, wherein a hood is equipped outside the head.

4. The head structure of the robot according to claim 1, wherein the head comprises a rear shell, an internal structure, and a front shell from back to front, wherein the eyes are mounted on the internal structure; the front shell is embedded with a hard rubber face and a soft rubber face, and an edge of the soft rubber face is adhered to the hard rubber face.

5. The head structure of the robot according to claim 4, wherein the mouth structure is mounted in a middle of the internal structure, and the mouth structure passes through the front shell, the hard rubber face and the soft rubber face and protrudes outward.

6. The head structure of the robot according to claim 4, wherein the internal structure comprises a neck connector, the three-link linkage, a basic frame, and a head printed circuit board (PCB).

7. The head structure of the robot according to claim 6, wherein a front of the basic frame is equipped with a left and right movement slider of eyes for driving the eyes to move left and right, and an up and down movement slider of eyes for driving the eyes to move up and down; a back of the basic frame is equipped with a fixing bracket of eye servo, and a right eye servo and a left eye servo are set on the fixing bracket of eye servo; the right eye servo controls the left and right movement slider of eyes to realize left and right movement of the eyes; and the left eye servo controls the up and down movement slider of eyes to realize up and down movement of the eyes.

8. The head structure of the robot according to claim 7, wherein the left and right movement slider of eyes and the up and down movement slider of eyes are assembled together to form an assembly, wherein a right eye joint and a left eye joint are equipped on the assembly.

9. The head structure of the robot according to claim 8, wherein the right eye joint has a first hole, wherein a right eye is inserted into the first hole; and the left eye joint has a second hole, wherein a left eye is inserted into the second hole.

10. The head structure of the robot according to claim 6, wherein circuits of the head are collected on the head PCB, and driven by a head servo; the neck connector is connected with a neck servo in the body.
